(19) United States
(12) Patent Application Publication
(10) Pub. No.: US 2004/0196904 A1
(43) Pub. Date: Oct. 7, 2004

(54) Digital broadcasting apparatus and method, video data encoding system and method, and broadcasting signal decoding system and method, which use variable bit rate

(75) Inventor: Kang-wook Chun, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/821,851

(22) Filed: Apr. 12, 2004

Related U.S. Application Data
(62) Division of application No. 09/985,021, filed on Nov. 1, 2001.

(30) Foreign Application Priority Data
Apr. 25, 2001 (KR) 2001-22425

(51) Int. Cl. H04N 7/12

(52) U.S. Cl. 375/240.03; 375/240.12; 375/240.16

(57) ABSTRACT

A digital broadcasting signal transmitting apparatus receives a digital broadcasting signal containing a video signal, an audio signal and data of additional information, encodes the digital broadcasting signal, converts into a predetermined transmission type, and transmits the converted signal, and includes a video analyzing portion that determines a bit rate allocated to the video signal and to the data of the additional information in accordance with the input video signal, and then outputs the determined bit rates, a video encoder that encodes the input video signal in accordance with the bit rate allocated to the video signal, and a data formatting portion that receives the data of the additional information as much as the bit rate allocated to the additional information, and then converts the received data into a predetermined data broadcasting format. Accordingly, a considerably increased amount of data of additional information can be transmitted.

### CROSS-REFERENCE TO RELATED APPLICATIONS

This application is a divisional of U.S. patent application Ser. No. 09/985,021, filed Nov. 1, 2001 and which is pending, and claims the benefit of Korean Application No. 2001-22425, filed Apr. 25, 2001, in the Korean Industrial Property Office, the disclosures of which are incorporated herein by reference.

### BACKGROUND OF THE INVENTION

1. Field of the Invention

The present invention relates to an apparatus to transmit a digital broadcasting signal, and more particularly, to an apparatus and a method to transmit a digital broadcasting signal, an apparatus and a method to encode video data, and a system and a method to decode the broadcasting signal that is capable of transmitting more data about additional information using a variable bit rate for a video signal having a constant bit rate by varying a bit rate of the video signal in accordance with a complexity of a video signal for a transmission.

2. Description of the Related Art

Recently, digital broadcasting services have undergone a remarkable market expansion throughout the U.S.A., European countries, and Japan by utilizing satellites or ground waves. The digital broadcasting services provide a complex array of multimedia services such as video broadcasting, audio broadcasting, and data broadcasting that includes additional information data broadcasting.

The data broadcasting service of the digital broadcasting services provides multimedia contents, such as text information, still video, product information, Electronic Program Guide (EPG), etc., that are the main part of the multimedia service of the digital broadcasting services.

The data broadcasting services are also useful for the broadcasting companies that could provide various types of information through the data broadcasting such as breaking news type news updates, sports events, real-time reports on stock transactions, weather reports, traffic information, home shopping, and TV program guides, or the like. Also, by providing push-type information updates to receivers, the broadcasting companies can allow the viewers to search their desired information more simply.

Currently, the digital broadcasting services provide data of 20-23 Mbps via one channel of a predetermined MHz (6 MHz in case of current U.S. ground wave broadcasting). For broadcasting purposes, the data signals of compressed video, audio, and additional information data have fixed bit rates, respectively. That is, the bit rates of the video, audio, and data broadcastings are predetermined for one channel, and the respective data services are provided at such predetermined bit rates.

FIG. 1A shows a conventional broadcasting signal having a fixed bit rate. Referring to FIG. 1A, the video data, audio data, and additional information data are transmitted at a constant bit rate (CBR) that has a fixed bit rate threshold. For example, when the 20 Mbps data is transmitted via one channel, the video data takes up the vast proportion of the bit rate by taking approximately 18 Mbps of the 20 Mbps data, followed by audio data and additional information data, which are transmitted at relatively lower bit rates.

Meanwhile, there can be video signals for broadcasting live activities such as sports events, or less live activities such as news programs. For the live activities, the vast amount of video data has to be compressed adequately to not exceed the fixed bit rate threshold. The video data of less live activities, such as a news program (i.e., the data of less amount) has to be compressed relatively less in order to meet the fixed bit rate threshold. And when the fixed bit rate threshold is not satisfied after the compression, dummy bits are added to meet the fixed bit rate threshold.

FIG. 1B shows one example of video data transmitted at a constant bit rate, and FIG. 1C shows one example of the broadcasting signal including audio data and additional information data to which the video data of FIG. 1B is adapted. In FIG. 1B, a cross-hatched region is the area for more compression, while a dotted region is the area for dummy bit insertion.

Accordingly, when transmitting the video data at the constant bit rate, the image quality depends on the characteristics of the videos. For example, since the data of a simple video is transmitted with the image quality higher than necessary in order to meet the constant bit rate, the channel utilization deteriorates.

As described above, the broadcasting process using the constant bit rates have considerable problems, especially in terms of channel utilization.

### SUMMARY OF THE INVENTION

In order to overcome the above and other problems of the related art, it is an object of the present invention to provide a digital broadcasting apparatus to transmit video data, audio data and additional information data at a fixed bit rate, which makes use of a variable bit rate by using a bit rate saved from an area of less video data for a transmission of data broadcasting.

Another object of the present invention is to provide a video data encoding apparatus and a method thereof that make use of a variable bit rate by inserting data about additional information in a user data region saved from a less video area of limited video signal bit rates.

Yet another object of the present invention is to provide a broadcasting signal decoding system and a method thereof to decode a broadcasting signal encoded by the above encoding apparatus and the method that make use of variable bit rates.

Additional objects and advantages of the invention will be set forth in part in the description which follows and, in part, will be obvious from the description, or may be learned by practice of the invention.

The above and other objects are accomplished by a digital broadcasting signal transmission apparatus that receives a digital broadcasting signal containing a video signal, an audio signal and data of additional information, encodes the digital broadcasting signal, converts the encoded signal into a predetermined transmission type, and transmits the converted signal, the digital broadcasting signal transmitting apparatus that uses a variable bit rate includes a video analyzing portion that determines a bit rate allocated to the video signal and to the data of the additional information in accordance with the input video signal, and then outputs the determined bit rates, a video encoder that encodes the input video signal in accordance with the bit rate allocated to the video signal, and a data formatting portion that receives the data of the additional information to the extent the bit rate allocated to the additional information allows, and then converts the received data of the additional information into a predetermined data broadcasting format.

According to an aspect of the present invention, the video analyzing portion includes a screen analyzing portion that analyzes a complexity of the input video signal, and outputs the analyzed complexity of the input video signal, a motion analyzing portion that calculates a difference between respective screens from the input video signal, and calculates a degree of motion of the screen based on the calculated difference, and outputs the calculated result about the degree of the motion, and a bit rate determining portion that receives the information about the video characteristics from the video encoder, and also receives the information about the complexity and degree of motion of the screen, and then determines the bit rates for the video signal and for the additional information.

According to another embodiment of the present invention, a broadcasting signal encoding apparatus that receives and encodes broadcasting data and uses a variable bit rate includes a broadcasting data analyzing portion that analyzes a complexity of the input broadcasting data, and determines an amount of user data that is insertable, a user data insertion portion that receives the data of the additional information for service and then inserts the data of the additional information as the user data in accordance with the determined amount of the user data that is insertable, and a transmitting portion that transmits the encoded broadcasting data and the inserted user data.

According to yet another embodiment of the present invention, a broadcasting signal decoding apparatus that receives and decodes broadcasting data containing encoded video data, encoded audio data, and encoded data of the additional information and uses a variable bit rate includes a user data outputting portion that outputs user data from the broadcasting data, and a data decoding portion that receives the output user data and decodes the received output user data to decode the data of the additional information.

According to still another embodiment of the present invention, a broadcasting signal decoding apparatus that receives broadcasting data containing encoded video data, encoded audio data, and encoded data of the additional information and uses a variable bit rate includes a user data outputting portion that outputs user data from the broadcasting data, an additional information data decoding portion that receives and decodes the data of the additional information, and a user data decoding portion that receives and decodes the output user data.

According to a further embodiment of the present invention, a digital broadcasting signal transmitting method of receiving a digital broadcasting signal containing a video signal, an audio signal and data of the additional information, encoding the digital broadcasting signal, converting the encoded signal into a predetermined transmission type, transmitting the converted signal and using a variable bit rate, includes determining a bit rate allocated to the video signal and a bit rate allocated to the additional information in accordance with the input video signal, and outputting the result, encoding the input video signal in accordance with the bit rate allocated to the video signal, and receiving the data of the additional information to the extent the bit rate allocated to the additional information allows, and converting the received data of the additional information into a predetermined data broadcasting format.

According to a yet further embodiment of the present invention, a method performed by a digital broadcasting signal transmitting apparatus for receiving and encoding broadcasting data, and using a variable bit rate includes analyzing a complexity of the received broadcasting data, and determining an amount of user data insertion, receiving the data of the additional information for service and then inserting user data in accordance with the determined amount of user data insertion, and transmitting the encoded broadcasting data and the inserted user data.

According to a still further embodiment of the present invention, a method of receiving and decoding broadcasting data containing encoded video data, encoded audio data, and encoded data of the additional information, and using a variable bit rate includes outputting the data of the additional information from the broadcasting data, and receiving and decoding the output data of the additional information.

According to a yet still further embodiment of the present invention, a method of receiving and decoding broadcasting data containing encoded video data, encoded audio data, and encoded data of the additional information, and using a variable bit rate includes outputting user data from the broadcasting data, and receiving the output user data and decoding the received user data to decode the data of the additional information.

According to an additional embodiment of the present invention, a method of receiving and decoding broadcasting data containing encoded video data, encoded audio data, and encoded data of the additional information, and using a variable bit rate includes outputting user data from the broadcasting data, and receiving and decoding the data of the additional information, and receiving and decoding the output user data.

### BRIEF DESCRIPTION OF THE DRAWINGS

These and other objects and advantages of the invention, and many of the attendant advantages thereof, will be more readily apparent and appreciated as the same becomes better understood by reference to the following detailed description of preferred embodiments thereof when considered in conjunction with the accompanying drawings in which like reference symbols indicate the same or similar components, wherein:

FIG. 1A is a view showing a conventional general broadcasting signal having a constant bit rate; FIG. 1B is a view showing a conventional example of video data being transmitted at the constant bit rate;

FIG. 1C is a view showing a conventional example of the broadcasting signal using the video data of FIG. 1B;

FIG. 2 is a block diagram showing a digital broadcasting transmitting apparatus in accordance with an embodiment of the present invention;

FIG. 3 is a block diagram of a video analyzing portion of FIG. 2;

FIG. 4 is a block diagram showing a digital broadcasting receiving apparatus in accordance with an embodiment of the present invention;

FIG. 5 is a block diagram showing a video data encoding apparatus in accordance with another embodiment of the present invention;

FIG. 6 is a view showing an example of the broadcasting signal being transmitted from the broadcasting signal encoding apparatus in accordance with a further embodiment of the present invention;

FIG. 7 is a block diagram showing a broadcasting signal decoding apparatus in accordance with an embodiment of the present invention;

FIG. 8 is a block diagram showing a broadcasting signal decoding apparatus in accordance with the another embodiment of the present invention; and

FIG. 9 is a block diagram showing the broadcasting signal decoding apparatus in accordance with a further embodiment of the present invention.

### DETAILED DESCRIPTION OF PREFERRED EMBODIMENT

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures. Any redundant explanation is omitted to the extent possible.

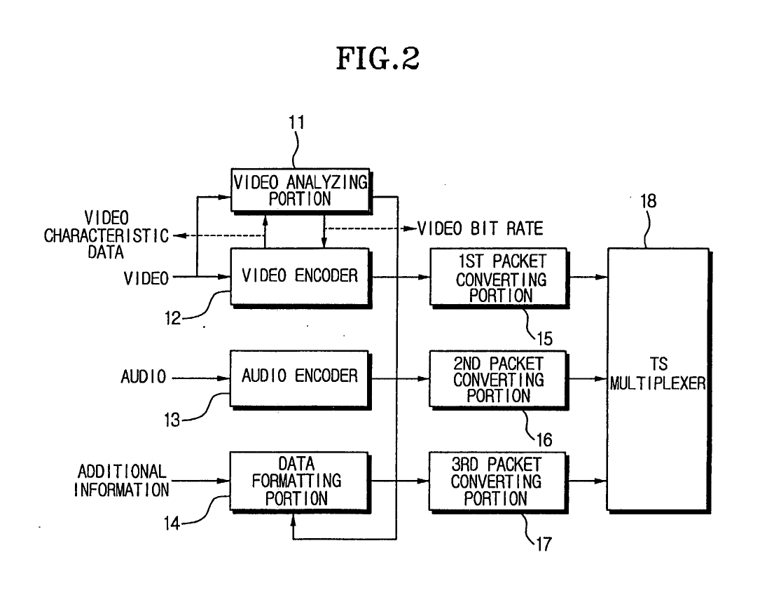

A digital broadcasting transmitting apparatus according to an embodiment of the present invention makes use of a variable bit rate to provide various multimedia services by saving the bit rates that would otherwise be wasted for the videos having less data. In FIG. 2, which is a block diagram of the digital broadcasting transmitting apparatus in accordance with the embodiment of the present invention, the digital broadcasting transmitting apparatus includes a video analyzing portion 11, a video encoder 12, an audio encoder 13, a data formatting portion 14, a first packet converting portion 15, a second packet converting portion 16, a third packet converting portion 17, and a TS multiplexer 18.

The video analyzing portion 11 receives video signals and video characteristic data generated by the video encoder 12, and determines a bit rate to be allocated to the video signal and a bit rate to be allocated to the transmission of the additional information. The operation of the video analyzing portion 11 will be described later in detail.

The video encoder 12 and the audio encoder 13 receive the video data and audio data respectively, and compress the received video and audio data at a predetermined bit rate into corresponding bit streams. The video encoder 12 generates the video characteristic data of the input video signal. The video encoder 12 receives the video bit rate for the video signal, which is variable by time, from the video analyzing portion 11, and encodes the video signal in accordance with the input video bit rate.

Here, the video characteristic data generated by the video encoder 12 includes various data that indicate the characteristics of the video signal. These characteristics include, but are not limited to, a quantizing level of the video signal, motion vectors, and an average image quality.

In accordance with the additional information bit rate for the additional information data received from the video analyzing portion 11, the data formatting portion 14 converts the format of the additional information data into a data broadcasting format that is predetermined by a digital broadcasting system. The first through third packet converting portions 15 through 17 receive the corresponding encoded video bit stream, the encoded audio bit stream, and the additional information data bit stream from the video encoder 12, the audio encoder 13, and the data formatting portion 14. The packet converting portions 15 through 17 convert the respective bit streams into packets of a predetermined length.

It is preferable, but not required, that the respective bit streams further include predetermined header information. The predetermined header information indicates that the encoded video bit stream or the additional information data bit stream is encoded at a variable bit rate, which helps to more efficiently decode the bit stream at the receiving apparatus that receives the video bit stream or the additional information data bit stream.

The packets generated from the first through third packet converting portions 15 through 17 are multiplexed by the TS multiplexer 18 so as to generate a Transport Stream (TS). The TS is modulated by a predetermined transmission method (e.g., 8-Vestigial Side Band of U.S. ground wave broadcasting), and transmitted.

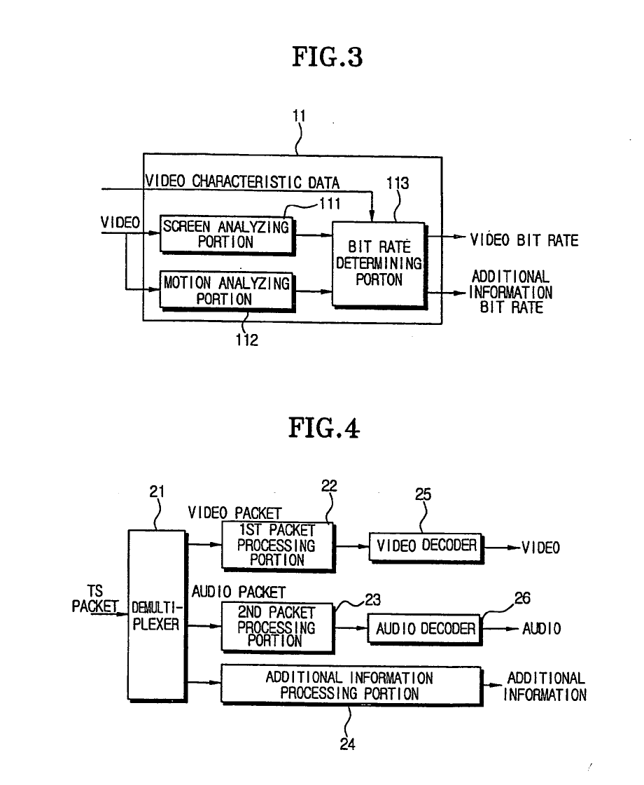

FIG. 3 is a block diagram of the video analyzing portion 11 of FIG. 2. The video analyzing portion 11 includes a screen analyzing portion 111, a motion analyzing portion 112, and a bit rate determining portion 113. The screen analyzing portion 111 analyzes the complexity of the input video signal, and outputs the analyzed result. The motion analyzing portion 112 calculates a difference between each screen based on the input video signals, and also calculates the degree of motion in the screen based on the calculated difference. Then the motion analyzing portion 112 outputs motion data about the motion.

The bit rate determining portion 113 uses the video characteristic data input from the video encoder 12, the screen complexity input from the screen analyzing portion 111, and the motion data input from the motion analyzing portion 112, and outputs the video bit rate and the additional information data bit rate. Preferably, the bit rate determining portion 113 determines a higher video bit rate as the complexity and motion of the screen become greater, and conversely determines a lower additional information data bit rate as the complexity and the motion of the screen increases. However, this is not required in all circumstances.

The bit rate determining portion 113 also may use only the video characteristic data input from the video encoder 12 to determine the video bit rate and the additional information data bit rate. In the above case, it is preferable that, as the average quantizing level of the video characteristic data becomes greater, or as the average motion vector becomes greater, the higher the determined video bit rate is. Conversely, the higher the video bit rate, the lower additional information data bit rate is determined. However, this is not required in all circumstances.

FIG. 4 is a block diagram of the digital broadcasting receiving apparatus in accordance with an embodiment of the present invention. The TS packet, input from a predetermined input end, is input to a demultiplexer 21, and divided and output in a video packet, audio packet, and additional information data packet, respectively. The video and the audio packets are input to first and the second packet processing portions 22 and 23, are converted into corresponding video and audio bit streams, and output. The video bit stream and the audio bit stream are input to a corresponding video decoder 25 and an audio decoder 26, and decoded into the video data and the audio data of the previous form before the compression, and output.

The additional information data packet is input to a corresponding packet dividing portion, and thus divided into a signal for controlling (i.e., synchronizing) the operation of the video and the audio decoders 25 and 26. An additional information data processing portion 24 processes the input additional information data in accordance with the data transmission method of the digital broadcasting system, and outputs the processed result. The data transmission method of the digital broadcasting system varies depending on the data broadcasting type provided by the respective broadcasting companies. Also, the output of the processed result also varies according to the type of the data broadcasting. For example, if the additional information is about the data broadcasting such as a stock transaction, the additional information usually includes codes of the respective companies, current prices, status of stock transaction, etc., which are tabled to be output.

Meanwhile, the data for data broadcasting output from the additional information processing portion 24 can be indicated by the combination of the decoded video signals or audio signals.

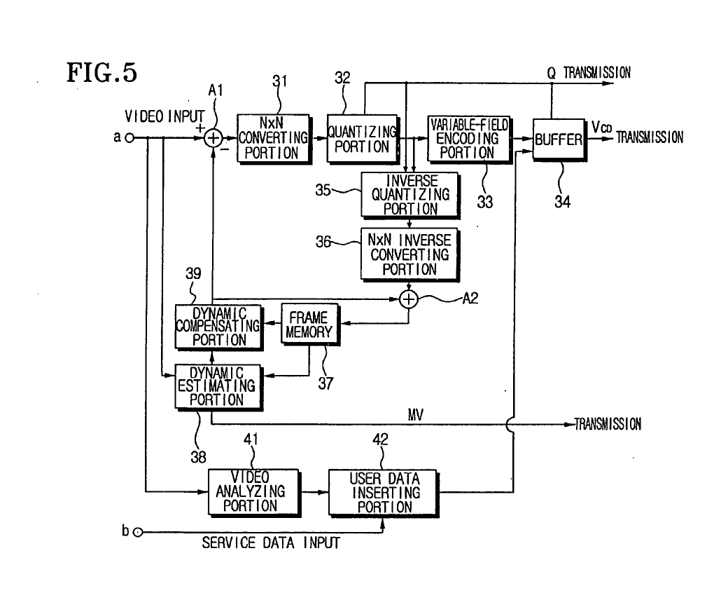

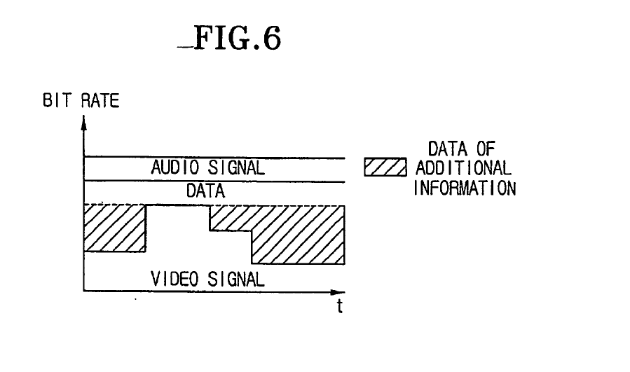

The video data encoding and decoding apparatuses in accordance with another embodiment of the present invention makes use of the variable bit rate by inserting the data of the additional information in a user data region, where the user data region is secured in an area of less video among the bit rates of limited video signals. FIG. 5 is a block diagram of the video data encoding apparatus in accordance with another embodiment of the present invention. The video data encoding apparatus includes an N×N converting portion 31 to convert video data of a predetermined block unit applied through an input end (a) into data within a frequency range, a quantizing portion 32 to quantize the converted conversion factor, a variable field encoding portion 33 to variable-field encode the quantized data, an inverse quantizing portion 35 to inverse-quantize the quantized data, an inverse N×N converting portion 36 to inverse convert the inverse-quantized signal, a frame memory 37, a motion estimating portion 38 and a motion compensating portion 39 to motion-estimate and compensate for the screens reconstructed by the inverse conversion and also for the blocks to be encoded, a video analyzing portion 41 to analyze and determine an amount of data to be inserted. In addition, a user data inserting portion 42 receives the data for service from an input (b) and transmits the received data in accordance with the amount of the data for user insertion. A buffer 34 receives and stores both the inconsistently input compressed video data and user data, and transmits the input compressed video and user data at a constant speed. Further, a quantization level to prevent overflow or underflow is transmitted from the quantizing portion 32 and a motion vector is transmitted from the dynamic estimating portion 38.

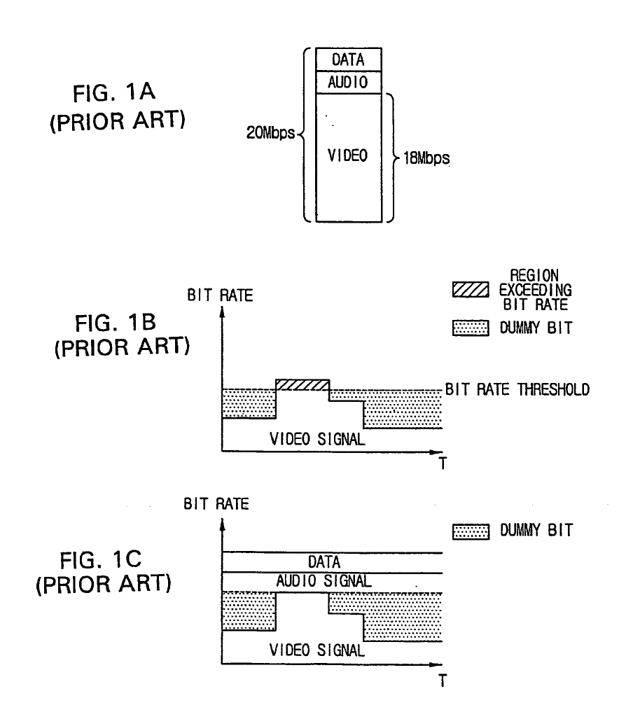

In the current broadcasting services, the video data, the audio data, and the additional information data have constant bit rates for the respective broadcastings as shown in FIG. 1A. Further, the video data has a construction in which a header is combined with the user data and the actual transmission data. A user data region is defined to be used by the broadcasting companies or by the transmitters of the broadcasting services. As described above, there occasionally is a case that the screen having less motion (i.e., the screen of less video data) is compressed accordingly less in order to meet the predetermined bit rate threshold. The problem with this is that, even according to the above conventional method, it is possible that the predetermined bit rate threshold is not met.

Accordingly, the video analyzing portion 41 analyzes the complexity of the input video data and determines how large the area is (cross hatching in FIG. 1B) that indicates the shortage of the video signal transmitted at the fixed bit rate from the predetermined bit rate threshold. Here, the region designated by the cross hatching indicates the area where the dummy bit data are conventionally added. The video analyzing portion 41 thus determines the amount of data about the additional information that is to be inserted in the cross hatching area of FIG. 1B instead of the dummy bit data.

The video analyzing portion 41 may directly receive the video data and calculate the complexity of the screen. Alternatively, the video analyzing portion 41 may receive the video characteristic information output from the video encoder 12 and determine the user data amount to be used for the transmission of the additional information data. Meanwhile, the complexity of the video data and the video characteristic information may also be used in combination. As described above, the video characteristic information includes information that indicates the characteristics of the video, such as a quantizing level of the currently encoded video, a motion vector, a quality of decoded video, etc.

Next, the user data inserting portion 42 receives the data for service through the input end (b), and transmits the received data by an amount that corresponds to the amount of the user data that can be inserted as determined by the screen complexity analyzing portion 41. The inserted additional information data is therefore transmitted in the user data region of the video data.

FIG. 6 is a view showing one example of the broadcasting signal transmitted in the broadcasting signal encoding apparatus in accordance with an embodiment of the present invention. As shown in FIG. 6, while the video data, the audio data, and the additional information data are maintained at a predetermined constant bit rate, within the bit rate allocated to the video data, the additional information data is added in the area of less video signals to maintain the video bit rate threshold indicated by the dashed line.

Examples of the additional information data currently available includes a transport packet type of 188 byte unit, a proprietary file format/service format type, a java byte code type, audio data, image data, video data, data broadcasting data, and a data service format provided by the broadcasting operator. The additional information data inserted in the user data region accordingly is one of the above types, but it is understood that other types of additional data exist and will be developed.

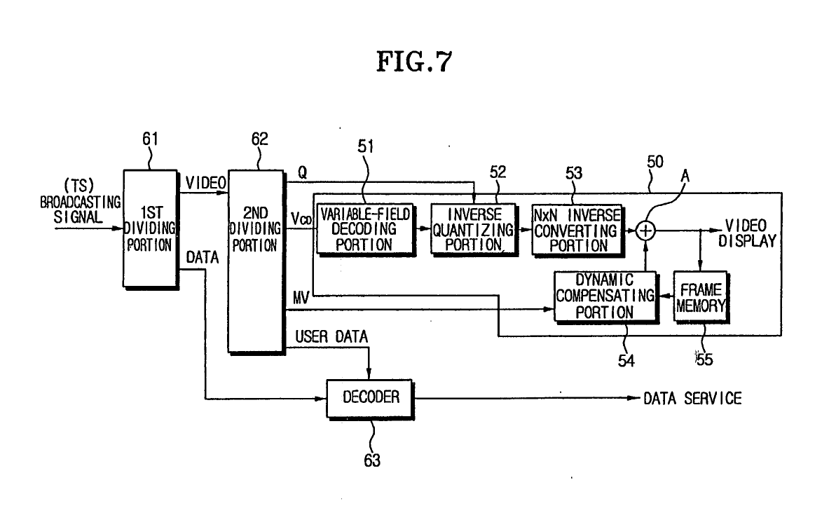

The decoding apparatus of the broadcasting apparatus in accordance with a further embodiment of the present invention will be described below with reference to FIG. 7. A transport stream input to the decoding apparatus of FIG. 7 includes video data allocated at a fixed bit rate, audio data, additional information data, and additional information data inserted at a variable bit rate in the video data region that is allocated at the fixed bit rate. The transport stream is divided into video data, audio data (not shown), and additional information data by a first dividing portion 61. The divided video data is input to a second dividing portion 62, from which the video data is re-divided and output as video coded data (VCD), motion vector (MV), and user data. The VCD is input to the video data decoding portion 50 to be decoded. The additional information data divided by the first dividing portion 61, and the user data output from the second dividing portion 62 are input to the data decoder 63 to be decoded to restore the complete data service.

The above-mentioned decoding apparatus is used in the case that the additional information data divided by the first dividing portion 61 and the user data from the second dividing portion 62 are in the same format. It is understood, but not shown, that a translator to translate the user data and/or the additional information data into a common format to be decoded by the data decoder 63.

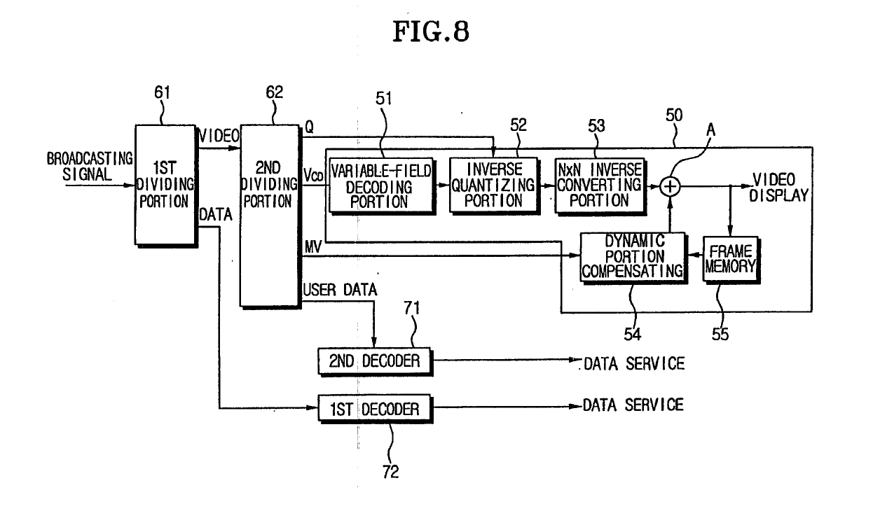

FIG. 8 is a block diagram of a further embodiment of the broadcasting signal decoding apparatus in accordance with the present invention. The additional information data divided by the first dividing portion 61 of the broadcasting signal decoding apparatus is input to the first decoder 72 to be decoded for a first data service. Further, the user data output from the second dividing portion 62 is input to the second decoder 71 to be decoded for a second data service. The first and second data services can be combined, but need not be combined in all instances. Accordingly, a broadcasting signal decoding apparatus may be used in the case that the additional information data divided by the first dividing portion 61 and the user data output from the second dividing portion 62 are in the respectively different formats.

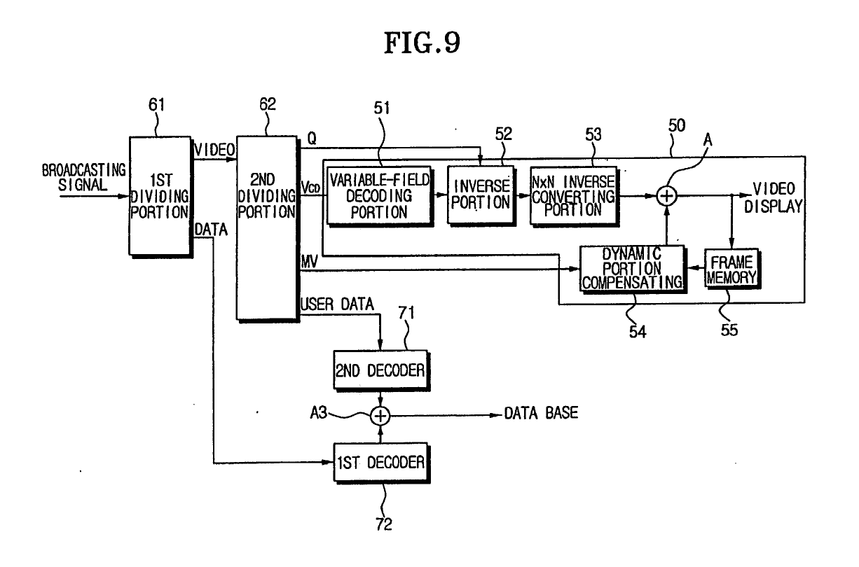

FIG. 9 is a block diagram for showing a yet further embodiment of the broadcasting signal decoding apparatus in accordance with the present invention. The additional information data divided by the first dividing portion 61 is input to the first decoder 72 to be decoded. The user data output from the second dividing portion 62 is input to the second decoder 72 to be decoded. The data decoded by the first decoder 72 and the data decoded by the second decoder 71 are added by an adder A3 to be output as a combined data service, such as a database.

Accordingly, the broadcasting signal decoding apparatus shown in FIG. 9 is used when the additional information data divided by the first dividing portion 61 and the user data output from the second dividing portion 62 are in the respectively different formats, but are also in the same display format with each other.

Although the above-described preferred embodiments are directed to the video data as an example, transmission of the additional information according to the present invention is also applicable to the audio data, or to combinations of the video and the audio data. Further, it is understood that the transmission can also occur by encoding the audio and/or video data, and the additional information data according the present invention on a recording medium to be reproduced from an appropriate player.

According to the present invention, a digital broadcasting transmitting apparatus and method thereof, a video data encoding apparatus and method thereof, and a broadcasting signal decoding system and method thereof make use of variable bit rate for a digital broadcasting system that compresses and transmits the video signal at a fixed bit rate, thereby minimizing damage to the video broadcasting quality and also securing an additional channel to provide various multimedia services there through.

The present invention uses a method of compressing data at a variable bit rate to meet a constant threshold, which has otherwise been known to be unacceptable for the digital broadcasting system that generally has fixed channel bit rates, thereby making use of the variable bit rate compression and transmission in the digital broadcasting system.

Although the preferred embodiments of the present invention have been described, it is understood that the present invention should not be limited to these preferred embodiments but various changes and modifications can be made by one skilled in the art within the spirit and scope of the present invention as hereinafter claimed, and equivalents thereof.

What is claimed is:

1. A digital broadcasting signal transmission apparatus that receives, encodes, and transmits a video signal, an audio signal, and additional information data, the digital broadcasting signal transmitting apparatus, comprising:
a video analyzing portion that determines a video bit rate allocated to the video signal and an additional information data bit rate allocated to the additional information data in accordance with the video signal, and outputs the determined video and additional information data bit rates;
a video encoder that encodes the video signal in accordance with the determined video bit rate; and
a data formatting portion that receives the additional information data in accordance with the determined additional information data bit rate, and converts the received additional information data into a predetermined data broadcasting format.

2. The digital broadcasting signal transmitting apparatus of claim 1, wherein said video encoder generates information about video characteristics of the video signal, and said video analyzing portion determines the video bit rate allocated to the video signal and the additional information data bit rate allocated to the additional information data using the video signal and the information about the video characteristics of the video signal.

3. The digital broadcasting signal transmitting apparatus of claim 2, wherein the information about the video characteristics of the video signal comprises at least one of a quantizing level, a motion vector, and an average quality of the video signal.

4. The digital broadcasting signal transmitting apparatus of claim 1, wherein said data formatting portion adds header information indicating the additional information data bit rate to an output bit stream of the additional information.

5. The digital broadcasting signal transmitting apparatus of claim 1, wherein said video analyzing portion comprises:
a screen analyzing portion that analyzes a complexity of the video signal, and outputs the analyzed complexity of the video signal;
a motion analyzing portion that calculates a difference between respective screens in the video signal, calculates a degree of motion of the screen based on the calculated difference, and outputs the calculated result about the degree of the motion; and
a bit rate determining portion that receives the information about the video characteristics from said video encoder, and also receives the information about the complexity and the degree of the motion of the screen, and determines the video signal and the additional information data bit rates using the received information.

6. The digital broadcasting signal transmitting apparatus of claim 1, wherein said video analyzing portion comprises a bit rate determining portion that determines the video signal bit rate and the additional information data bit rate using only the data of the video characteristics input from said video encoder.

7. A broadcasting signal encoding apparatus that receives and encodes broadcasting data, comprising:
a broadcasting data analyzing portion that analyzes a complexity of the broadcasting data, and determines an amount of user data to be inserted into a user data region of the broadcasting data;
a user data inserting portion that receives additional information data and inserts the additional information data into the user data in accordance with the determined amount of the user data to be inserted into the user data region as user data; and
a transmitting portion that transmits the encoded broadcasting data and the inserted user data including the additional information data.

8. The broadcasting signal encoding apparatus of claim 7, wherein the broadcasting data is video data.

9. The broadcasting signal encoding apparatus of claim 7, wherein the broadcasting data is audio data.

10. A broadcasting signal decoding apparatus that receives and decodes broadcasting data containing encoded video data, encoded audio data, and encoded data of additional information, the broadcasting signal decoding apparatus comprising:
a user data outputting portion that detects user data in the received broadcasting data, and outputs the user data; and
a data decoding portion that receives the output user data, and decodes the received user data to decode the data of the additional information.

11. The broadcasting signal decoding apparatus of claim 10, wherein said user data outputting portion comprises:
a first dividing portion that divides the received broadcasting data into video data, audio data, and data of the additional information; and
a second dividing portion that detects and outputs the user data from one of the video data and the audio data received from the first dividing portion.

12. A broadcasting signal decoding apparatus that receives broadcasting data containing encoded video data, encoded audio data, and encoded data of additional information, the broadcasting signal decoding apparatus comprising:
a user data outputting portion that outputs user data from one of the video and audio data of the received broadcasting data;
an additional information data decoding portion that receives and decodes the data of the additional information from the broadcasting data; and
a user data decoding portion that receives and decodes the output user data.

13. The broadcasting signal decoding apparatus of claim 12, wherein said user data outputting portion comprises:
a first dividing portion that divides the broadcasting data into video data, audio data, and data of additional information; and
a second dividing portion that outputs user data from one of the video data and audio data.

14. The broadcasting signal decoding apparatus of claim 12, further comprising an adder that adds first data decoded by said additional information data decoding portion and second data decoded by said user data decoding portion when the data of the additional information and the output user data have a same display format.

15. A digital broadcasting signal transmitting method for receiving and transmitting an encoded a digital broadcasting signal containing a video signal, an audio signal and data of additional information, the method comprising:
determining a video bit rate allocated to the video signal and an additional information bit rate allocated to the additional information in accordance with the video signal, and outputting the determined video and additional information bit rates;
encoding the video signal in accordance with the video bit rate allocated to the video signal; and
receiving the data of the additional information to the extent the additional information bit rate allocated to the additional information allows, and converting the received data of the additional information into a predetermined data broadcasting format,
wherein said determining the video and additional information bit rates further comprises:
analyzing a complexity of the video signal, and outputting the analyzed complexity of the video signal;
calculating a difference between respective screens from the video signal, and calculating a degree of motion of the screens based on the calculated difference, and outputting the calculated result about the degree of the motion; and
receiving the information about the video characteristics from the video encoder, receiving the information about the complexity and degree of motion of the screen, and determining the video and additional information bit rates for the video signal and for the additional information according to the received information.

16. A digital broadcasting signal transmitting method for receiving and transmitting an encoded a digital broadcasting signal containing a video signal, an audio signal and data of additional information, the method comprising:
determining a video bit rate allocated to the video signal and an additional information bit rate allocated to the additional information in accordance with the video signal, and outputting the determined video and additional information bit rates;
encoding the video signal in accordance with the video bit rate allocated to the video signal; and
receiving the data of the additional information to the extent the additional information bit rate allocated to the additional information allows, and converting the received data of the additional information into a predetermined data broadcasting format,
wherein said determining the video and additional information bit rates further comprises determining the video bit rate for the video signal and the additional information bit rate for the additional information by using only the data about the video characteristics.

17. A method of receiving and encoding broadcasting data using a digital broadcasting signal transmitting apparatus, the encoding method comprising:
analyzing a complexity of the received broadcasting data, and determining an amount of user data that is insertable;
receiving data of additional information for service and inserting the data of the additional information as user data in the received broadcasting data in accordance with the determined amount of the user data that is insertable; and
transmitting the encoded broadcasting data having the inserted user data.

18. The encoding method of claim 17, wherein the broadcasting data comprises video data.

19. The encoding method of claim 17, wherein the broadcasting data comprises audio data.

20. The encoding method of claim 17, wherein the data of the additional information comprises video data.

21. The encoding method of claim 17, wherein the data of the additional information comprises audio data.

22. The encoding method of claim 17, wherein the data of the additional information comprises data broadcasting data.

23. A decoding method for receiving and decoding broadcasting data containing encoded video data, encoded audio data, and encoded data of additional information, the decoding method comprising:
outputting the data of the additional information from one of the encoded audio and video data of the broadcasting data; and
receiving and decoding the output data of the additional information.

24. A decoding method for receiving and decoding broadcasting data containing encoded video data, encoded audio data, and encoded data of additional information, the decoding method comprising:
outputting user data from the broadcasting data; and
receiving the output user data and decoding the received user data to decode the data of the additional information.

25. The decoding method of claim 24, wherein said outputting the user data further comprises:
first dividing the broadcasting data into the video data, the audio data, and the data of the additional information; and
second dividing one of the divided video data and the audio data to output the user data.

26. A decoding method for receiving and decoding broadcasting data containing encoded video data, encoded audio data, and encoded data of additional information, the decoding method comprising:
outputting user data from the broadcasting data;
receiving and decoding the data of the additional information; and
receiving and decoding the output user data.

27. The decoding method of claim 26, wherein said outputting the user data further comprises:
first dividing the broadcasting data into the video data, the audio data, and the data of the additional information; and
second dividing one of the divided video data and the audio data to output the user data.

28. The decoding method of claim 26, further comprising adding the decoded data of the additional information and the decoded user data when the data of the additional information and the output user data are in the same display format.

29. A data encoder to encode first and second data, where the first data is encoded at a first bit rate below a threshold bit rate, the encoder comprising:
a data analyzer to analyze the received first data and to determine the first bit rate and a second bit rate;
a first data encoder to encode the first data at the first bit rate;
a second data formatter to format the second data in accordance with the second bit rate; and
a combiner unit to combine the encoded first data and the formatted second data to form a combined data to be output at the threshold bit rate.

30. The data encoder of claim 29, further comprising third data, wherein said second data formatter further formats the third data at a constant third data bit rate.

31. The data encoder of claim 30, wherein the second and third data have different formats.

32. The data encoder of claim 30, wherein the second and third data have a same format and comprise an input data service.

33. The data encoder of claim 29, wherein said combiner unit comprises a transport stream multiplexer that multiplexes the encoded first data and the formatted second data to produce a transport stream.

34. The data encoder of claim 29, wherein the transport stream multiplexer further performs 8-vestigial band modulation to modulate the transport stream.

35. The data encoder of claim 29, wherein the first data is one of video and audio data.

36. The data encoder of claim 35, wherein the first data is video data, and said data analyzer determines the first bit rate in accordance with a complexity of the video data and motion information of the video data calculated in accordance with differences between screens and degrees of information based upon the calculated differences.

37. The data encoder of claim 35, wherein said data analyzer determines the first bit rate in accordance with characteristics of the first data detected by said first data encoder.

38. The data encoder of claim 37, wherein the first data is video data, and the characteristics detected by said first data encoder comprise one of quantizing levels of the video data, motion vectors of the video data, and an average image quality of the video data.

39. The data encoder of claim 29, wherein the first data comprises a user data portion, wherein the formatted second data is inserted into the user data portion.

40. The data encoder of claim 39, further comprising a buffer to receive and store the encoded first data and the formatted second data to be inserted into the user data portion of the encoded first data, and to output the combined data at a constant bit rate.

41. The data encoder of claim 40, wherein the first data comprises video data, and said first data encoder comprises:
an N×N converting portion to convert the video data into data within a frequency range,
a quantizer to quantize the data within the frequency range received from the N×N converting portion,
a variable field encoding portion to variable field encode the quantized data to produce the encoded video data stored in said buffer, and
motion estimating and compensating portions to motion estimate and compensate the quanized data.

42. A data decoder for decoding encoded first and second data, the data decoder comprising:
a separator to receive the encoded first and second data as an encoded combined data having a constant bit rate, and to remove and separately output the encoded first and second data;
a first data decoder to detect the first bit rate and to decode the encoded first data encoded at the first bit rate;
a second data decoder to detect the second bit rate and to decode the encoded second data encoded at the second bit rate; and
a third data separator to receive and separate encoded third data and the encoded combined data, to output the encoded third data, and to output the encoded combined data to said separator,
wherein
the constant bit rate comprises the combined first and second bit rates, and
said third data separator outputs the third data to said second data decoder to be decoded and combined with the decoded second data.
